(19) United States
(12) Patent Application Publication
(10) Pub. No.: US 2021/0132985 A1
(43) Pub. Date: May 6, 2021

(54) SHADOW LATCHES IN A SHADOW-LATCH CONFIGURED REGISTER FILE FOR THREAD STORAGE

(71) Applicant: ADVANCED MICRO DEVICES, INC., Santa Clara, CA (US)

(72) Inventors: Michael ESTLICK, Fort Collins, CO (US); Erik SWANSON, Fort Collins, CO (US)

(21) Appl. No.: 16/668,469

(22) Filed: Oct. 30, 2019

(51) Int. Cl. G06F 9/48; G06F 9/30

(52) U.S. Cl. CPC G06F 9/4843; G06F 9/30112; G06F 9/30101

(57) ABSTRACT

A processing system includes a processor core and a scheduler coupled to the processor core. The processing system executes a first active thread and a second active thread in the processor core and detects a swap event for the first active thread or the second active thread. Based on the swap event, using a shadow-latch configured fixed mapping system, to the processing system replaces either the first active thread or the second active thread with a shadow-based thread, the shadow-based thread being stored in a shadow-latch configured register file.

### BACKGROUND

Processing devices, such as central processing units (CPUs), graphics processing units (GPUs), or accelerated processing units (APUs), implement multiple threads that are often executed concurrently in the execution pipeline. Some active threads that are available for execution are stored in registers, while other inactive threads are stored in system memory that is located external to the processing device. Loading a thread from memory into the register is a long latency operation that executes through caches and load-store units of the processing system. For example, loading a thread from main memory (such as a RAM) may take several cycles to return the thread. Processor space limitations and cost considerations limit the number of registers available for thread storage in the processing device, which ultimately limits the number of threads that are available for execution.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of an execution pipeline of a processor core in accordance with some embodiments.

FIG. 2A is a block diagram of a portion of a processing system utilizing the processor core of FIG. 1 according to some embodiments.

FIG. 2B is a block diagram of a portion of a processing system utilizing the processor core of FIG. 1 according to some embodiments.

FIG. 3 is a flow diagram illustrating a method for using shadow latches for storing threads in the processor core of FIG. 1 in accordance with some embodiments.

FIG. 4 is a block diagram of a floating point unit of the execution pipeline of the processor core in FIG.1 in accordance with some embodiments.

FIG. 5 is a bitcell layout of a shadow-latch configured register file in the processor core of FIG. 2 in accordance with some embodiments.

FIG. 6 is a block diagram of a shadow-latch configured register file in the processor core of FIG. 2 in accordance with some embodiments.

### DETAILED DESCRIPTION

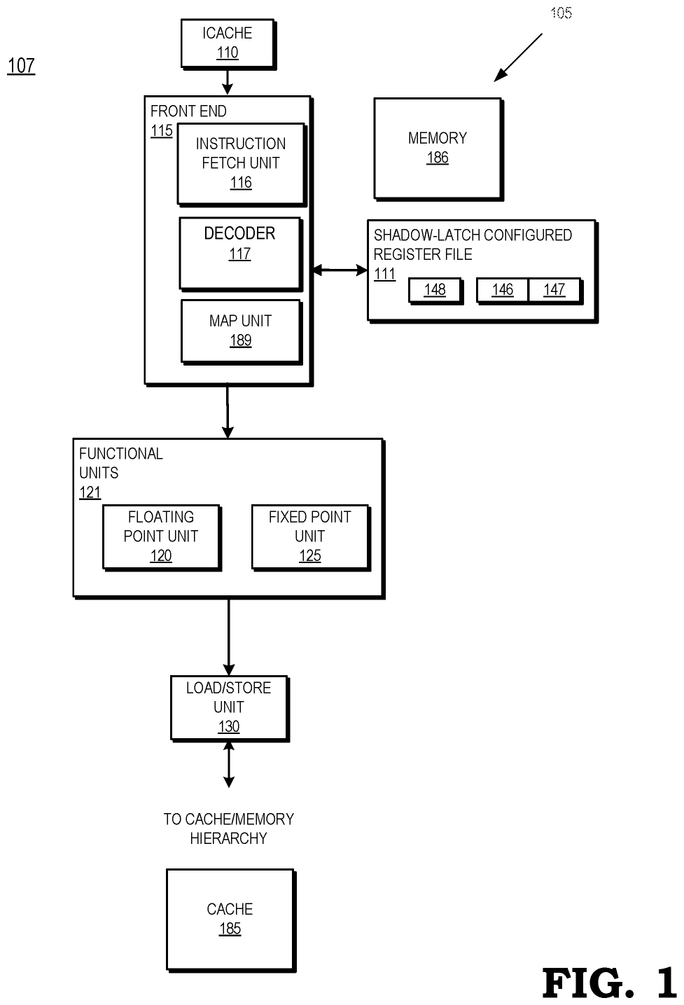

FIGS. 1-6illustrate systems and techniques for storing threads in a shadow-latch configured register file of a processor core in a processing system. A shadow-latch configured register file in the processing system includes shadow latches and shadow multiplexers that allow threads to be stored discretely in the shadow-latch configured register file as shadow-based threads. The shadow-based thread is different than a normal thread in that it is stored in shadow latches, as opposed to regular latches. The additional shadow latches and shadow multiplexers utilize limited additional space in the processing system, while still allowing the processing system to store additional threads. A thread scheduler in the processing system schedules use of both active and inactive threads that are stored shadow-latch configured register file for use by the processor core. The shadow-latch configured register file of the processor core utilizes the shadow latches for inactive threads and the regular latches for the active threads. A swap operation is conducted by micro-operations (micro-ops) in the thread scheduler of the processing system that swap out the active threads with the inactive threads that are located in the shadow latches when, for example, the active threads have stalled or completed execution. Due to the inactive threads (the shadow-based threads) being stored locally at the shadow-latch configured register file, the latency normally associated with attaining inactive threads from system memory is reduced.

FIG. 1 illustrates a processor core 107 of a processor having an execution pipeline 105 in accordance with some embodiments. The illustrated processor core 107 can include, for example, a central processing unit (CPU) core based on an x86 instruction set architecture (ISA), an ARM (a registered trademark of ARM Limited) ISA, and the like. The processor can implement a plurality of such processor cores, and the processor can be implemented in any of a variety of electronic devices, such as a notebook computer, desktop computer, tablet computer, server, computing-enabled cellular phone, personal digital assistant (PDA), set-top box, game console, and the like.

In the depicted example, the execution pipeline 105 includes an instruction cache 110 (“Icache”), a front end 115, and functional units 121. The functional units 121 include one or more floating point units 120, and one or more fixed point units 125 (also commonly referred to as “integer execution units”). The processor core 107 also includes a load/store unit (LSU) 130 and a shadow-latch configured register file 111 coupled to a memory hierarchy (not shown), including one or more levels of cache (e.g., L1 cache, L2 cache, etc.), a system memory, such as system RAM, and one or more mass storage devices, such as a solid-state drive (SSD) or an optical drive.

The instruction cache 110 stores instruction data that is fetched by an instruction fetch unit 116 of the front end 115 in response to demand fetch operations (e.g., a fetch to request the next instruction in the instruction stream identified by the program counter) or in response to speculative prefetch operations.

Memory accesses, such as load and store operations, are issued to the load/store unit 130. The front end 115 decodes instructions fetched by the instruction fetch unit 116 into one or more operations or threads that are to be performed, or executed, by, for example, either the floating point unit 120 or the fixed point unit 125 of functional unit 121. The threads or operations involving floating point calculations are dispatched to the floating point unit 120 for execution, whereas the operations involving fixed point calculations are dispatched to the fixed point unit 125.

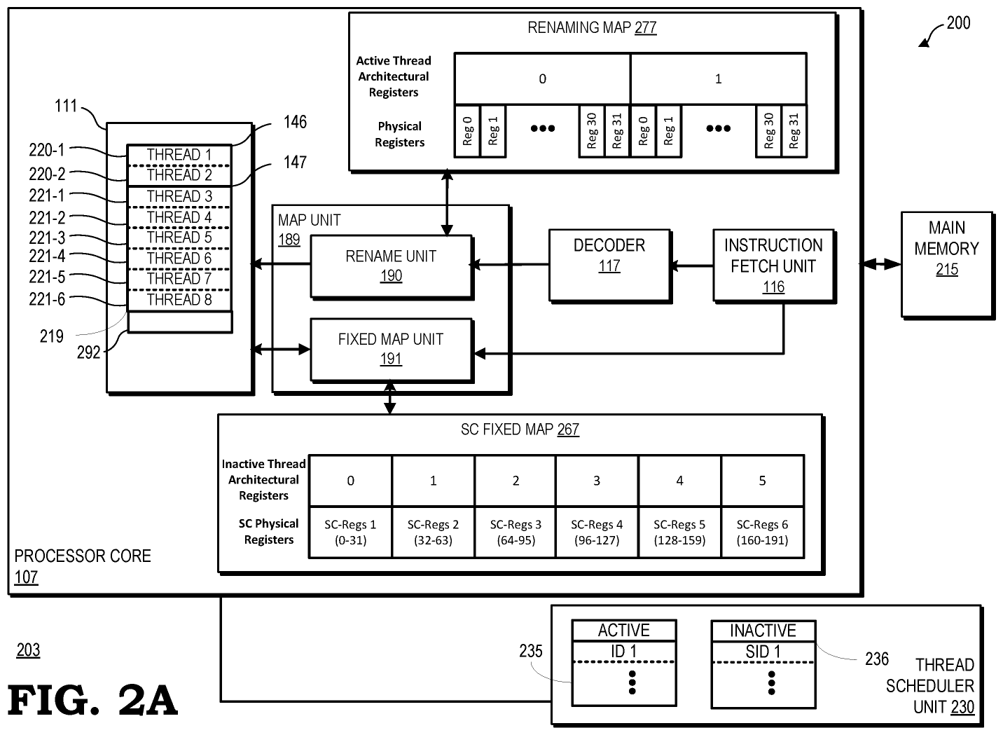

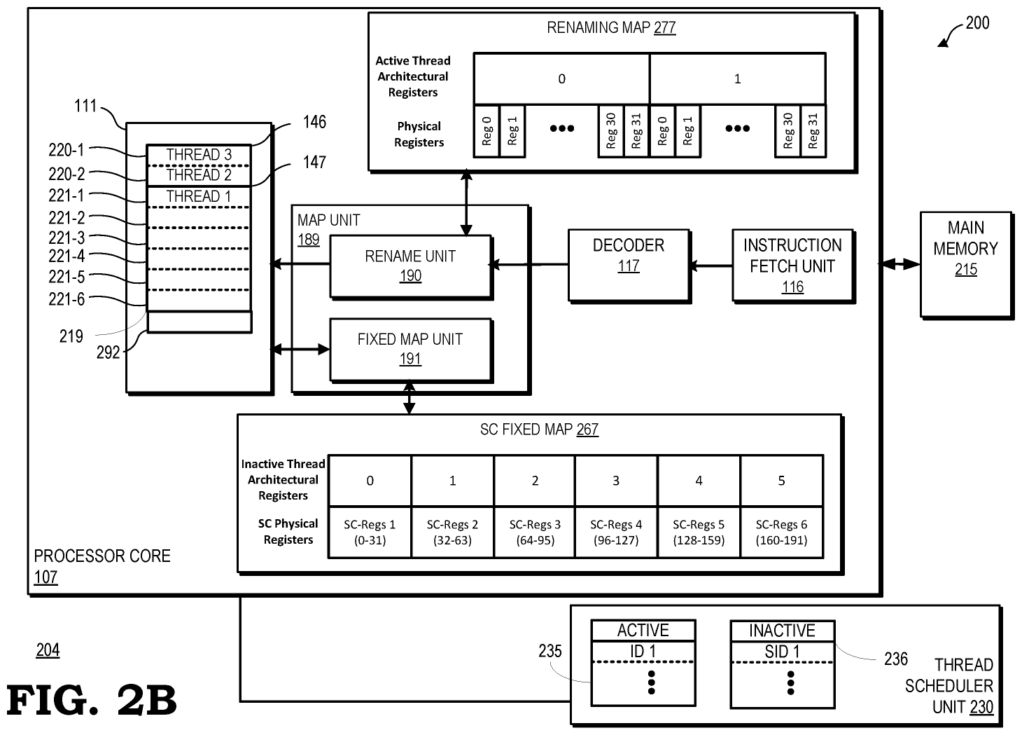

Processor core 107 is part of a multi-thread processing system that includes shadow-latch configured register file 111 that utilizes shadow latches 147 and shadow multiplexers 148 that allow shadow-based threads to be stored discretely in the register file. That is, shadow-latch configured register file 111 is a register file that, in addition to including typical functional or regular latches 146 that are used to store active threads, includes shadow latches 147 that are used to store inactive threads. Shadow-latch configured register file 111 also includes shadow multiplexers 148 that select the shadow-based threads from the shadow latches 146 to read from and load for execution in the processor core 107. The threads (both the inactive and active threads) are scheduled for execution in processor core 107 by a scheduler, described further below with respect to FIG. 2. During operation, if either of the active threads that are stored in the regular latches 146 encounter a swap event during execution, such as, for example, a stall event or an thread completion event, the scheduler switches or replaces the active thread with a shadow-based thread that is stored in the shadow latch 147 by having the shadow multiplexer 148 select the shadow-based thread from the shadow latch 147. The shadow multiplexer 148 is used to transfer the shadow-based thread directly to the pipeline from the shadow latch 147. Thus, instead of having to fetch an inactive thread from cache 185 or system memory 186, the shadow-based thread may be accessed from shadow-latch configured register file 111.

FIG. 2A illustrates a portion 203 of a processing system 200 that includes the processor core 107 of FIG.1 according to some embodiments. The portion 203 includes a processor core 107 that is coupled to a main memory 215 and a thread scheduler unit 230. The processor core 107 and main memory 215 in the embodiment shown in FIG. 2 are coupled so that threads scheduled by thread scheduler unit 230 are passed between the processor core 107 and the main memory 215, and further so that inactive threads and active threads are passed between shadow-latch configured registers and regular registers in shadow-latch configured register file 111 (described further in detail below).

In some embodiments, in addition to performing traditional instruction fetch unit operations, instruction fetch unit 116 fetches a plurality of threads (e.g., THREADS 1-8) from main memory 215. Initially, instruction fetch unit 116 fetches a first subset of the plurality of threads (e.g., THREAD 1 and THREAD 2) which are active threads purposed by thread scheduler unit 230 for immediate execution by processor core 107. The first subset of threads are decoded by decoder 117, renamed using rename unit 190 of map unit 189, and stored in shadow-latch configured register file 111 as active threads. Subsequently, or at the same time, instruction fetch unit 116 fetches a second subset of threads (e.g., THREAD 3-THREAD 8), which are inactive threads purposed for execution at a later time scheduled by thread scheduler unit 230. In some embodiments, the second subset of threads are not decoded by decoder 117 for immediate execution, but instead are mapped using fixed map unit 191 and stored directly in the shadow-latch configured register file 111 as inactive threads for processing at a subsequent time.

In some embodiments, instead of a second subset of inactive threads being fetched by instruction fetch unit 116, after the active threads have been fetched, only a single inactive thread is fetched at a time from memory 251 to replace an active thread in shadow-latch configured register file 111. That is, an active thread that has been stored in the active registers of shadow-latch configured register file 111 is transferred to inactive registers of shadow-latch configured register file 111. The inactive thread that has been fetched by instruction fetch unit 116 is decoded by decoder 117, renamed using rename unit 190, and stored in active registers of the shadow-latch configured register file 111. In some embodiments, the process of filling the shadow-latch configured registers of shadow-latch configured register file 111 with inactive threads continues until, for example, all of the shadow-latch configured registers are filled with inactive threads that can no longer be swapped for active threads based on, for example, the scheduling of the threads using thread scheduler unit 230.

In order to facilitate the storage of active and inactive threads in shadow-latch configured register file 111, the processor core 107 implements a plurality of sets of registers (register sets) 219 in shadow-latch configured register file 111 to store threads (i.e., active and inactive threads) that can be executed by the processor core 107. In some embodiments, the plurality of sets of registers 219 include active register sets 220, inactive register sets 221 (also known as shadow-latch configured register sets 221), and a temporary register set 292. Active register sets 220 includes an active register set 220-1 and an active register set 220-2 that store active threads. Inactive register sets 221 include an inactive register set 221-1, an inactive register set 221-2, an inactive register set 221-3, an inactive register set 221-4, an inactive register set 221-5, and an inactive register set 221-6 that store inactive threads. Temporary register set 292 is a set of registers that store a thread during the transfer of a thread or threads from the active registers (220-1-220-2) to the inactive registers (221-1-221-6). In some embodiments, each register set includes, for example, 32 registers per set. In other embodiments, each register set may have fewer or more registers. In some embodiments, additional registers in register sets 219 are provided as needed for the storage of additional threads. In some embodiments, fewer registers in register sets 219 are provided as needed for the storage of a lesser number of threads.

In order to allocate the threads for storage by processor core 107, map unit 189, in addition to performing traditional register renaming using rename unit 190 and renaming map 277, also performs fixed mapping of the architectural registers of the inactive threads to the physical shadow-latch configured registers (SC physical registers) using fixed map unit 191 and a shadow-latch configured fixed map (SC-fixed map) 267.

During the register renaming operation, each architectural register referred to in the thread (e.g., each source register for a read thread operation and each destination register for a write thread operation) is replaced or renamed with the physical register (e.g., a physical regular latch register set). Thus, for register renaming, the regular latches 146 utilized for the registers in register set 220-1 and register set 220-2 are used in a traditional renaming scheme, where architectural registers are mapped to the regular latch physical registers of shadow-latch configured register file 111 using renaming map 277. As illustrated in FIG. 2A, renaming map 277 includes a mapping of active threads (e.g., active thread 0 and active thread 1) to the physical registers of register sets 220-1 and 220-2. That is, for the example provided in renaming map 277, active thread 0 is mapped to physical registers 0-31 of register set 220-1 and architectural registers of active thread 1 are mapped to physical registers 0-31 of register set 220-2.

For the mapping of inactive thread architectural registers to the shadow-latch configured physical registers, the shadow latches 147 utilized for the shadow-latch configured registers of shadow-latch configured register sets 221-1, 221-2, 221-3, 221-4, 221-5, and 221-6 are mapped in a fixed relationship to inactive threads architectural registers in SC fixed map 267. For the example provided in SC fixed map 267, in order to form the fixed relationship, six inactive threads with architectural register numbers of 0, 1, 2, 3, 4, and 5 are each mapped to one-hundred ninety physical shadow-latch configured registers.

In this case, the physical shadow-latch configured registers 0-31 are directly mapped to inactive thread architectural register 0, physical shadow-latch configured registers 32-63 are directly mapped to inactive thread architectural register 1, physical shadow-latch configured registers 64-95 are directly mapped to inactive thread architectural register 2, physical shadow-latch configured registers 96-127 are directly mapped to inactive thread architectural register 3, physical shadow-latch configured registers 128-159 are directly mapped to inactive thread architectural register 4, physical shadow-latch configured registers 160-191 are directly mapped to inactive thread architectural register 5. The fixed mapping of the shadow-latch configured registers 221-1-221-6 to the inactive threads in a fixed map allows the inactive threads to be free of having to use separate renaming maps, as is the case for the registers that utilize the regular latches.

The thread scheduler unit 230, which, in addition to being implemented in hardware, in some embodiments is software located in the operating system (OS) of the processing system 200, is used to schedule threads in the processor core 107 based on, for example, load balancing that includes the state of the active threads. Although the thread scheduler unit 230 is depicted as an entity separate from the processor core 107, some embodiments of the thread scheduler 230 may be implemented in the processor core 107. Micro-ops, which in some embodiments are included as part of thread scheduler unit 230, perform swapping operations to switch or replace the threads in the shadow-latch configured register file 111.

In some embodiments, in order to perform scheduling operations for the active and inactive threads, the thread scheduler 230 stores information indicating identifiers of threads that are ready to be scheduled for execution (active threads) in an active list 235 and those that are ready for execution after the active threads have executed or stalled (inactive threads). For example, the active list 235 includes an identifier (ID 1) of a first thread that is active and stored in the regular latches of registers 220, and the inactive list 236 includes an identifier (SID 1) of a first thread that is inactive and stored in the shadow latches of registers 221. The micro-ops use the identifier IDs to swap active threads with inactive threads that are located in the shadow-latch configured register file 111.

As illustrated in FIG. 2A, shadow-latch configured register file 111 has stored two active threads (THREAD 1 and THREAD 2) in register sets 220-1 and 220-2 of the shadow-latch configured register file 111 that are being executed by processor core 107. Threads 3-8 (THREAD 3-THREAD 8), which are inactive threads, have been stored in the shadow-latch configured registers 221-1-221-6 of the shadow-latch configured register file 111 and have been identified as shadow-based threads in inactive list 236. In some embodiments, a thread is designated as a shadow-based thread when the thread is inactive and stored in the shadow-latch configured register sets 221-1-221-6 of shadow-latch configured register file 111.

In some embodiments, during a swap event, such as a stall of one of the active threads, micro-ops recognize the swap event and switch the active thread (e.g., THREAD 1 or THREAD 2) with a shadow-based thread (e.g., THREAD 3, THREAD 4, THREAD 5, THREAD 6, THREAD 7, or THREAD 8) located in the shadow-latch configured register file 111.

In some embodiments, in order to swap an active thread for inactive thread, during a first operation, an active thread, such as, for example, THREAD 1 or THREAD 2, is read from active register set 220 using the rename unit 190 of map unit 189 to ascertain the location the physical register corresponding to the architectural register number provided by the thread. For example, for an active thread architectural register number of 0 corresponding to THREAD 1, the physical register ascertained by map unit 189 corresponds to the physical registers 0-31 of active register set 220-1. After ascertaining the physical registers that correspond to the active thread, the thread is read from, for example, register set 220-1 and written to temporary register set 292. Temporary register set 292 is a set of registers that are used to temporarily store active or inactive threads during the transfer of an active thread/s from active register sets 220 to inactive register sets 221. The number and size of registers in temporary register set 292 is equivalent to the number and size of registers in active register sets 220 and inactive register sets 221.

During a second operation, after the active thread (e.g., THREAD 1) has been written to temporary register set 292, the inactive thread (e.g., a thread from THREAD 3-8) is read from inactive register sets 221 (i.e., shadow-latch configured register sets 221 having shadow latches 147) using the fixed mapping relationship of SC fixed map 267. That is, map unit 189 uses SC fixed map 267 to ascertain the shadow-latch configured physical registers that correspond to the architectural register number provided by the inactive thread. For example, when the architectural register number provided is 3, THREAD 6 is read from SC physical registers 96-127, which correspond to active register set 221-4. After the inactive thread (e.g., THREAD 6) has been read, the inactive thread (e.g., THREAD 6) is written to active register sets 220 using the renaming map 277. After being transferred from inactive register sets 221 to active register sets 220, the inactive thread (e.g., THREAD 6) transitions to an active thread and is so noted in thread scheduler unit 230.

During a third operation, the active thread that was written to temporary register 292 (e.g., THREAD 1) is read from temporary register 292 and written to the inactive thread register set 221-4, the location of the previous inactive thread that was swapped with the active thread. After the transfer of the active thread (e.g., THREAD 1) to the inactive register set 221-4 and the transfer of the inactive thread (e.g., THREAD 6) to the active register set 220-1, the swapping operation is complete. Since the shadow-based threads (i.e., the inactive threads) are located locally, i.e., in the shadow-latch configured register file 111, latency time in accessing the threads from, for example, main memory 215 is reduced.

FIG. 2B illustrates an example of a portion 204 of a processing system 200 that utilizes the shadow-latch configured register file 111. In the illustrated example, only two active threads (e.g., THREAD 1 and THREAD 2) have been stored in active registers 220-1 and 220-2. An active thread (e.g., THREAD 1) has been transferred to the inactive register set 221-1 and has now become inactive. A subsequent thread (e.g., THREAD 3) has been fetched from memory 215, decoded by decoder 117, renamed using rename unit 190 of map unit 189, and stored in active register set 220-1 using fixed map unit 191. That is, in FIG. 2B, instead of a second subset of inactive threads being fetched by instruction fetch unit 116, only a single inactive thread (e.g., THREAD 3) is fetched at a time from memory 251 to replace an active thread (e.g., THREAD 1 or THREAD 2) in shadow-latch configured register file 111. Thus, to perform the swapping operation, an active thread (e.g., THREAD 1 or THREAD 2) that has been stored in the active register sets 220 of shadow-latch configured register file 111 is transferred directly to inactive register sets 221 of shadow-latch configured register file 111 using SC fixed map 267. The inactive thread (e.g., THREAD 3) that has been fetched by instruction fetch unit 116 is decoded by decoder 117, renamed using rename unit 190, and stored in an active register set 220-1 of the shadow-latch configured register file 111. In some embodiments, the process of filling the shadow-latch configured registers of shadow-latch configured register file 111 with inactive threads continues until, for example, all of the shadow-latch configured registers of shadow-latch configured register sets 221 are filled with inactive threads that can no longer be swapped for active threads based on, for example, a maximum capacity limitation of shadow-latch configured register sets 221 based on the scheduling of the threads using thread scheduler unit 230.

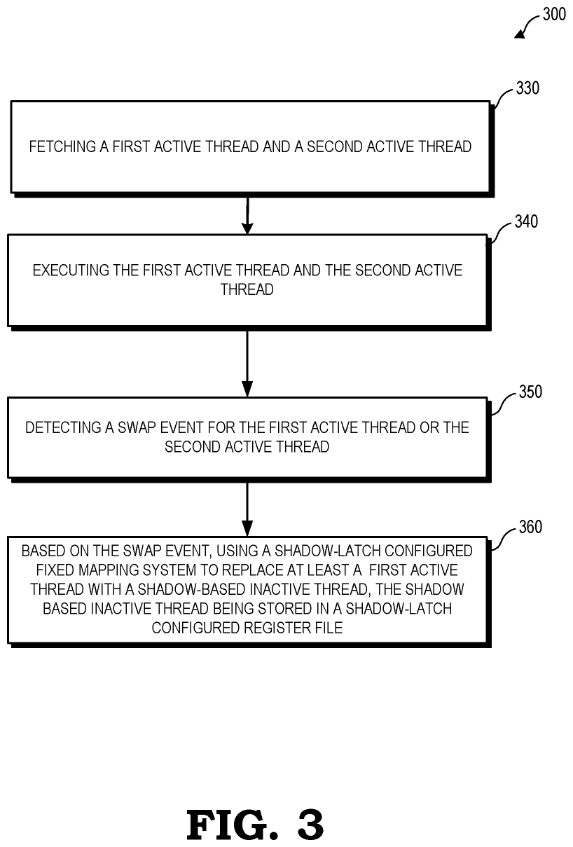

FIG. 3 illustrates a method 300 for using shadow latches for storing threads in the processing of FIG. 1 in accordance with some embodiments. With reference to FIGS. 1 and 2, method 300 begins at start block 330, where a first active thread (THREAD 1) and a second active thread (THREAD 2) are fetched. At block 340, processor core 107 executes the first active thread and the second active thread. The first thread and second thread are stored in regular latches in shadow-latch configured register file 111. At block 350, a swap event is detected, such as, for example, a stall event or a completed execution event. At block 360, based on the swap event, either the first active thread (THREAD 1) or the second active thread (THREAD 2), is replaced with a shadow-based thread (SB-THREAD) from a plurality of shadow-based threads (i.e., SB-THREAD 1, SB-THREAD 2, etc.) using a shadow-latch configured fixed mapping system. The shadow-based threads are stored in shadow latches of the shadow-latch configured register. In this manner, processor core 107 is able to access shadow-based threads locally, i.e., from the shadow-latch configured register file 111, instead of having to access the threads from system memory.

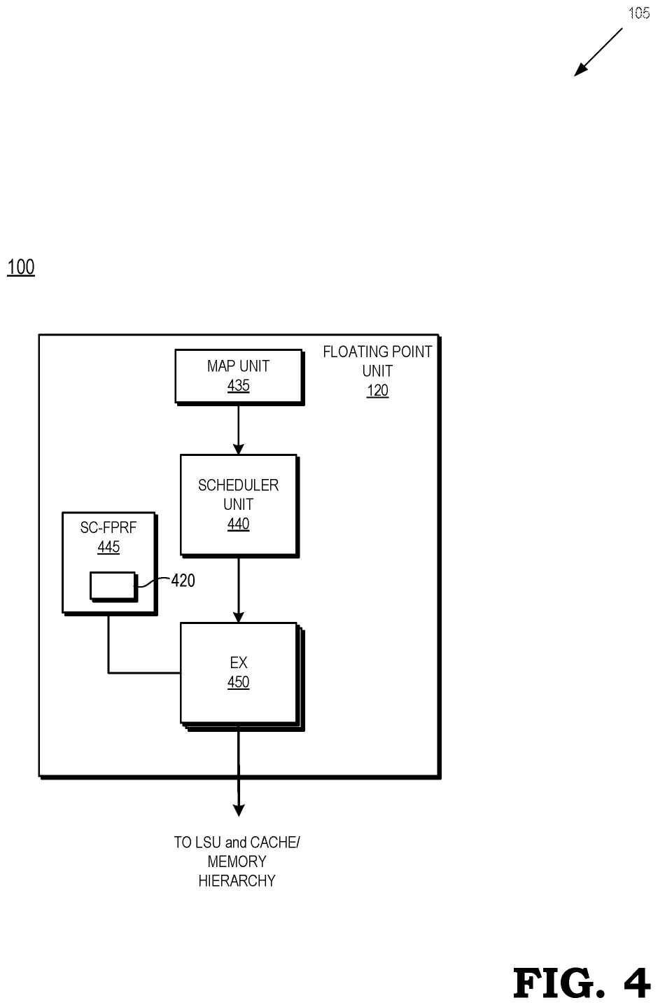

FIG. 4 illustrates an example of the floating point unit 120 in processor core 107 of FIG. 1 that utilizes a shadow-latch configured floating point register file 445 to store shadow-based threads. The floating point unit 120 includes a map unit 435, a scheduler unit 440, a shadow-latch configured floating point register file (SC-FPRF) 445, and one or more execution (EX) units 450. Similar to the shadow-latch configured register file 111 described above, the SC-FPRF 445 includes shadow latches to store active and inactive threads associated with floating-point operations.

In an operation of the floating point unit 120, the map unit 135 receives thread operations from the front end 115 (usually in the form of operation codes, or opcodes). These dispatched operations typically also include, or reference, operands used in the performance of the represented operation, such as a memory address at which operand data is stored, an architected register at which operand data is stored, one or more constant values (also called “immediate values”), and the like. Scheduler unit 440 schedules the threads stored in SC-FPRF 445 for execution in execution units 450. SC-FPRF 445 is configured with shadow latches and shadow MUXs that allow inactive threads to be stored in registers 420 of SC-FPRF 445. Similar to the swap operation described above with respect to the shadow-latch configured register file 111 of FIG. 1, a swap operation is conducted by micro-ops in the scheduler unit 440 that swap out the active threads with the inactive threads when, for example, the instructions of the active threads have completed. The swap is performed using a floating point micro-op that reads a shadow-based thread from SC-FPRF 445 and writes a renamed thread to the shadow latches of SC-FPRF 445, and vice versa. In some embodiments, since the inactive threads (shadow-based threads) are located in the SC-FPRF 145, the micro-op only utilizes the SC-FPRF 145 of the floating point unit 120 for inactive thread access during execution, and does not use the caches, the load storage unit, or system memory for access to the inactive threads.

In some embodiments, floating point unit 120 is a 512-bit floating point unit capable of handling 512 bit wide floating point operations. Floating point unit 120 has a plurality of registers 420 in SC-FPRF 445 for thread storage. For example, in some embodiments, floating point unit 120 has 32 registers per thread, where two threads are executed simultaneously, while six threads are stored in SC-FPRF 445 as inactive. Thus, in some embodiments, for the case of a 512 bit operation, a swap can be performed utilizing a temporary register in the floating point unit 120 with three operations, for a total of 32*3 or 96 operations. In one embodiment, the micro-op is executed in, for example, four pipelines, for a 96/4 or 24 cycles to swap a thread. In various embodiments, a state machine is used to achieve a 64/4=16 cycle latency by avoiding writing to temporary registers.

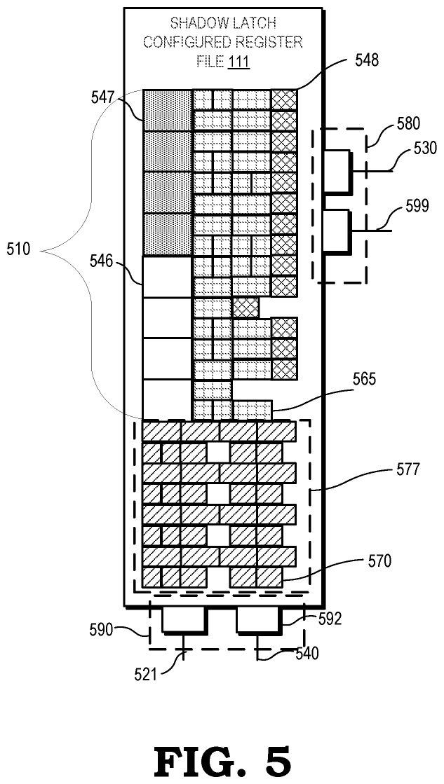

An example shadow-latch configured register file 111 is schematically illustrated in FIG. 5, in which a single register entry 510 is depicted. The register entry 510 is illustrated with active thread latches 546 and inactive thread latches 547. Although four active thread latches 546 and four inactive thread latches are illustrated in FIG. 5, it is appreciated that the register entry 510 may include a different number of active thread latches and inactive thread latches capable of storing various amounts of thread data, such as, for example, 256 or 512 bit thread data. Although only a single register entry 510 is depicted in FIG. 5, the shadow-latch configured register file 111 can include additional register entries.

As depicted, the shadow-latch configured register file 111 includes more than one thread storage element (active thread latches 546 and inactive (shadow) thread latches 547) and thread select MUXs 548 per register entry 510. In some embodiments, a thread select MUX 548 includes first level of thread selection logic that selects between the thread storage elements that are to be read (i.e., inactive thread latches 547 and active thread latches 546) within the register entry 510. In addition to storing inactive threads, the additional storage provided by the inactive thread latches 547 may be used to store, for example, the architectural state for inactive threads.

In some embodiments, in order to perform read operations, the shadow-latch configured register file 111 further includes a read port 580 for receiving the thread select MUX signal 530 and outputting thread data 599. Shadow-latch configured register file 111 also includes read logic circuitry 565 for accessing and outputting the thread data associated with the threads in the active thread latches 546 and inactive thread latches 547.

In some embodiments, access to the inactive thread latches 547 and the active thread latches 546 of the register entry 510 occurs by receiving thread select MUX signal 530 (globally, per pipe 105, or per read port 580) indicating which of the shadow select latch or the regular latch of the inactive thread latches 546 and active thread latches 547, respectively contains the thread data to be accessed. The thread data read from the active thread latches 547 or inactive thread latches 546 is output from shadow-latch configured register file 111 using the read logic circuitry 565 and is provided as thread data output 599.

Shadow-latch configured register file 111 also includes a write port 590 that uses write logic circuitry 577 to write thread data to the active thread latches 546 and the inactive thread latches 547. In some embodiments, write logic circuitry 577 includes a write MUX 570 that uses a write MUX signal 540 to write thread data to the active thread latches 546 and the inactive thread latches 547.

When the write MUX signal 540 is indicative of a shadow latch in the inactive thread latches 547, the thread data (which are associated with the inactive threads since they have been directed to be stored in the inactive thread latches 547) are written to the inactive thread latches 547 using write logic circuitry 577. When the write MUX signal 540 is indicative of an active latch in active thread latches 546, the thread data associated with the active threads are written to the active thread latches 546 using write logic circuitry 577.

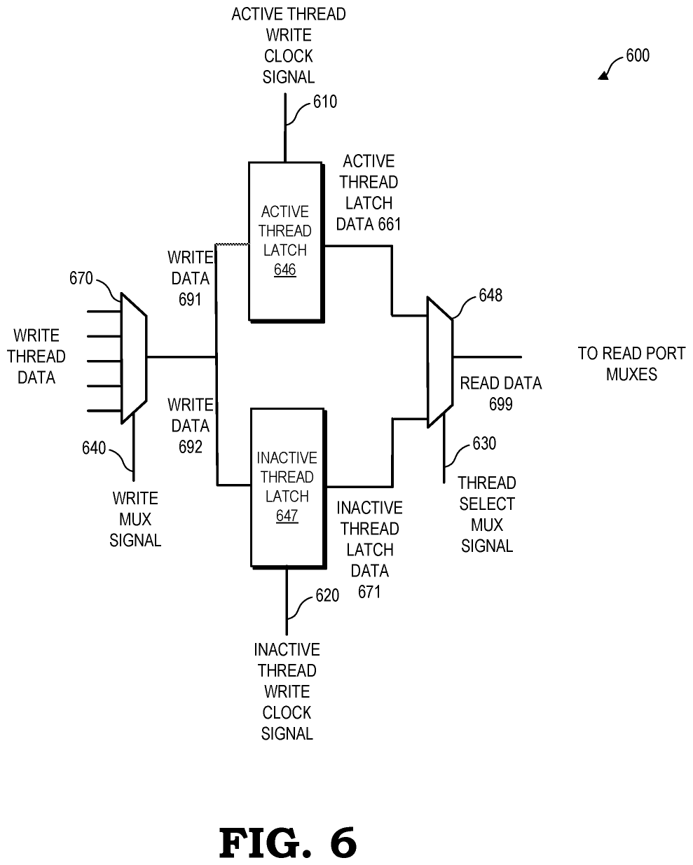

FIG. 6 is a block diagram of shadow-latch configured register file 111 of the processor core 107 of FIG. 2 in accordance with some embodiments. Shadow-latch configured register file 111 includes a write MUX 670, active thread latch 646, inactive thread latch 647, inactive thread select MUX 648. In various embodiments, the two latches (e.g., active thread latch 646 and inactive thread latch 647) share a single write MUX 670, but utilize different write clocks (e.g., active thread write clock signal 610 and inactive thread write clock signal 620) during the writing process.

During a write operation, at the write port of shadow-latch configured register file 111, write MUX 670 receives write data (e.g., 512-bit data) that is to be written to the active thread latch 646 or the inactive thread latch 647. Based on write MUX signal 640, when the active thread write clock signal 610 logic value is high, write MUX 670 directs write data 691 to be written to active thread latch 646. When the inactive thread write clock signal 620 logic value is high, write MUX 670 directs write data 692 to inactive thread latch 647. Active thread latch 646 and inactive thread latch 647 store the received write data 691 and write data 692, respectively. During a read operation, active thread latch 646 and inactive thread latch 647 release active thread latch data 661 and inactive thread latch data 671 based on, for example, the logic value of thread select MUX signal 630 that controls thread select MUX 648. In some embodiments, when, for example, the logic value of thread select MUX signal 630 is low, active thread latch data 661 is read from active thread latch 646 as read data 699. When thread select MUX signal 630 is high, inactive thread latch data 671 is read from inactive thread latch 647 as read data 699. Read data 699 is then provided via read port MUXs as output of shadow-latch configured register file 111.

In some embodiments, the shadow-latch configured register file 111 is only accessible in specific operating modes or using a specific access mechanism, e.g., double-pump. That is, in some embodiments, control of the extra address bit may be limited to a specific subset of micro-ops, through, for example, a consecutive read access pattern (e.g., double-pump) or through some other mechanism.

In some embodiments, the apparatus and techniques described above are implemented in a system including one or more integrated circuit (IC) devices (also referred to as integrated circuit packages or microchips), such as the processing system described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc , magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method, comprising:
executing a first active thread and a second active thread in a processor core;
detecting a swap event for the first active thread or the second active thread; and
based on the swap event, using a shadow-latch configured fixed mapping system to replace either the first active thread or the second active thread with a shadow-based thread, the shadow-based thread being stored in a shadow-latch configured register file.

2. The method of claim 1, wherein:
the shadow-latch configured register file includes a plurality of shadow latches, at least one of the plurality of shadow latches being used to store the shadow-based thread.

3. The method of claim 2, wherein:
the shadow-latch configured register file includes a plurality of shadow multiplexers (MUXs), the plurality of shadow MUXs being used to select the shadow latches with the shadow-based thread that replaces the first active thread or the second active thread.

4. The method of claim 1, wherein:
the shadow-latch configured register file is a floating point register file.

5. The method of claim 1, wherein:
the shadow-latch configured register file stores a plurality of active threads and a plurality of inactive threads.

6. The method of claim 5, wherein:
the plurality of active threads are stored in functional latches and the plurality of inactive threads are stored in a plurality of shadow latches in the shadow-latch configured register file.

7. The method of claim 5, wherein:
the plurality of active threads include the first active thread and the second active thread; and
the plurality of inactive threads include the shadow-based thread.

8. The method of claim 1, wherein:
a scheduler schedules a time at which at least one of the first active thread and the second active thread is to be swapped with the shadow-based thread.

9. A processing system, comprising:
a processor core; and
a scheduler coupled to the processor core, wherein the processing system is configured to:
execute a first active thread and a second active thread in the processor core;
detect a swap event for the first active thread or the second active thread; and
based on the swap event, using a shadow-latch configured fixed mapping system to replace either the first active thread or the second active thread with a shadow-based thread, the shadow-based thread being stored in a shadow-latch configured register file.

10. The processing system of claim 9, wherein:
the shadow-latch configured register file includes a plurality of shadow latches, at least one of the plurality of shadow latches being used to store the shadow-based thread.

11. The processing system of claim 10, wherein:
the shadow-latch configured register file includes a plurality of shadow multiplexers (MUXs), the plurality of shadow MUXs being used to select the shadow latches with the shadow-based thread that replaces the first active thread or the second active thread.

12. The processing system of claim 9, wherein:
the shadow-latch configured register file is a floating point register file.

13. The processing system of claim 9, wherein:
the shadow-latch configured register file stores a plurality of active threads and a plurality of inactive threads.

14. The processing system of claim 13, wherein:
the plurality of active threads are stored in functional latches and the plurality of inactive threads are stored in a plurality of shadow latches in the shadow-latch configured register file.

15. The processing system of claim 13, wherein:
the plurality of active threads include the first active thread and the second active thread; and
the plurality of inactive threads include the shadow-based thread.

16. The processing system of claim 9, wherein:
the scheduler schedules a time at which at least one of the first active thread and the second active thread is to be swapped with the shadow-based thread.

17. A non-transitory computer readable medium embodying a set of executable instructions, the set of executable instructions to manipulate at least one processor to:
execute a first active thread and a second active thread in a processor core;
detect a swap event for the first active thread or the second active thread; and
based on the swap event, using a shadow-latch configured fixed mapping system to replace either the first active thread or the second active thread with a shadow-based thread, the shadow-based thread being stored in a shadow-latch configured register file.

18. The non-transitory computer readable medium of claim 17, wherein:
the shadow-latch configured register file includes a plurality of shadow latches, at least one of the plurality of shadow latches being used to store the shadow-based thread.

19. The non-transitory computer readable medium of claim 18, wherein:
the shadow-latch configured register file includes a plurality of shadow multiplexers (MUXs), the plurality of shadow MUXs being used to select the shadow latches with the shadow-based thread that replaces the first active thread or the second active thread.

20. The non-transitory computer readable medium of claim 17, wherein:
the shadow-latch configured register file is a floating point register file.
